(19) United States
(12) Patent Application Publication
(10) Pub. No.: US 2021/0362894 A1
(43) Pub. Date: Nov. 25, 2021

(54) HANDHELD VACUUM SEALER DEVICE

(71) Applicant: Sunbeam Products, Inc., Boca Raton, FL (US)

(72) Inventors: John Kenneth Michie, Kalamazoo, MI (US); Zakary Edward Hartman, Parkland, NJ (US); Yiyun Zhou, Xiamen (CN)

(21) Appl. No.: 17/397,575

(22) Filed: Aug. 9, 2021

Related U.S. Application Data
(63) Continuation of application No. 16/364,861, filed on Mar. 26, 2019, now abandoned.
(60) Provisional application No. 62/648,162, filed on Mar. 26, 2018.

(51) Int. Cl. B65B 31/04; B65B 25/00; B65D 81/20

(52) U.S. Cl. CPC B65B 31/041; A23V 2002/00; B65D 81/2038; B65B 25/001

(57) ABSTRACT

A handheld vacuum sealer device is provided for drawing a vacuum to remove air from a bag or container to prolong freshness of food stored in the bag or container. The sealer device includes an activation button to initiate drawing the vacuum that is activated at the same time a user pushes downwardly on the sealer device to form a seal between the sealer device and the bag or container. A charging cradle for recharging the sealer device is also provided that charges the sealer device regardless of the orientation of the sealer device when the sealer device is placed within the charging cradle.

### CROSS-REFERENCE TO RELATED APPLICATIONS

This application is a continuation of U.S. patent application Ser. No. 16/364,861, filed on Mar. 26, 2019, which claims priority to U.S. Provisional Application No. 62/648,162, filed Mar. 26, 2018 and titled “HANDHELD VACUUM SEALER DEVICE.” U.S. application Ser. No. 16/364,861 and 62/648,162 are hereby fully incorporated by reference as if set forth fully herein.

### TECHNICAL FIELD OF THE INVENTION

The present invention relates generally to food storage. More particularly, it relates to a handheld cordless vacuum sealer for use with storage containers and/or bags so that food products may be stored within the container or bag in a freezer, refrigerator, pantry or other food storage area under vacuum until ready for use.

### BACKGROUND OF THE INVENTION

Storing food, vegetables, herbs, preparation ingredients and leftovers is common practice. Often these products are stored in ordinary food storage bags or containers which can be placed in freezers, refrigerators, pantries and other storage locations, and closed using an interlocking seal or zipper closure. Over short periods of time, food stored in ordinary food storage bags will spoil, waste, or become unusable and will have to be thrown away. Thus, vacuum sealing food products within a bag has been known to extend the freshness and useful life of food products stored, thereby reducing food waste and spoilage.

Handheld cordless vacuum sealers are often used in the industry to vacuum seal products inside of a bag and/or container. They may also be used with various other accessories like wine stoppers to draw air out from within a vessel like a wine bottle. Typically, to begin the vacuuming process, handheld vacuum sealers are first placed so that a vacuum portion of the vacuum sealer is aligned with a port on a bag or container, or a nozzle associated with the vacuum portion is aligned with a port on an accessory. When the vacuum portion or nozzle and the port are aligned and subsequently sealingly engaged (e.g., by pushing the sealer down onto the bag or container), an activation button of the sealer is used to activate a vacuum pump within the sealer. Typically that activation button is placed on the side of the vacuum sealer.

Thus, the prior art vacuum sealer requires two steps to perform its function. First, a user must push downwardly on the sealer to form a seal with the port on the bag, container, or accessory. Second, a user must depress the activation button on the sealer to initiate the sealing process. A streamlined process where only one step is required would present an improvement in the art.

Handheld cordless vacuum sealers in the prior art are typically powered using rechargeable batteries. To recharge the batteries however, a cord may need to be plugged into the side of the sealer to recharge the rechargeable batteries. Alternatively, and more simply than having to plug a cord into the sealer, the sealer can be placed in a recharging cradle. However, prior art charging cradles require that the sealer be placed in the cradle in a particular orientation so that charging contacts of the sealer align with charger contacts in the cradle that deliver power to the device via the charging contacts on the device. A simpler, quicker charging solution is desired that does not require any particular sealer device orientation.

### SUMMARY OF THE INVENTION

A handheld cordless vacuum sealer is provided for use with FoodSaver® containers, zipper bags, and accessories to remove air from within the containers, bags, or accessories and preserve freshness of food stored therein.

The device includes a rotary diaphragm pump for quiet operation while maintaining optimal vacuum performance. Three ⅓ AA Ni-MH batteries may be utilized in the device to provide power to the device. A large activation button on the top of the device may be pressed easily and automatically when a user presses the device down onto the vacuum port associated with the containers, bags, or accessories to be vacuum-sealed. There may also be a clear reservoir at bottom of the device to capture liquids which are removable for easy cleaning.

A charging base with 360° electrical contacts is also provided to charge the device when placed in any orientation on the base. The charging base may include a cord wrap feature to allow the user to adjust the cord length.

These aspects are merely illustrative of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is a front elevation view of a handheld vacuum sealer device contained within a charging cradle constructed according to an example embodiment of the present invention;

FIG. 2 is a front elevation view the charging cradle FIG. 1;

FIG. 3 is a top perspective view of the charging cradle of FIGS. 1 and 2;

FIG. 4 is a top perspective view of the handheld vacuum sealer device of FIG. 1;

FIG. 5 an exploded view of the handheld vacuum sealer device of FIGS. 1 and 4;

FIG. 6 is an enlarged cross sectional view of a reservoir of the handheld vacuum sealer device of FIGS. 1 and 4-5;

FIG. 7 is a top plan view of the reservoir of FIG. 6;

FIG. 8 is a bottom perspective view of the handheld vacuum sealer device of FIGS. 1 and 4-6 including an accessory nozzle for engagement with a vacuum accessory; and

FIG. 9 is a perspective view of the vacuum sealer device of FIGS. 1 and 4-6 being used to vacuum seal a bag.

### DETAILED DESCRIPTION

In the following detailed description numerous specific details are set forth in order to provide a thorough understanding of the invention. However, it will be understood by those skilled in the art that the present invention may be practiced without these specific details. For example, the invention is not limited in scope to the particular type of industry application depicted in the figures. In other instances, well-known methods, procedures, and components have not been described in detail so as not to obscure the present invention.

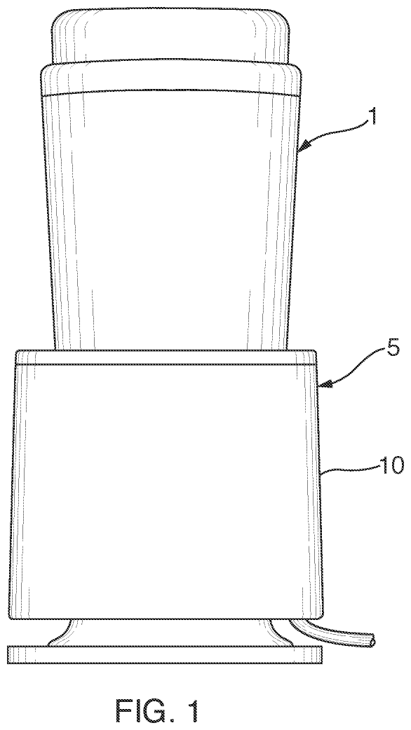

Turning first to FIG. 1, a handheld vacuum sealer device (hereinafter referred to as “hand sealer 1”) is shown and illustrated as having been received within a charging cradle 5. The sealer device 1 may be used to remove air from within a container or bag in order to preserve freshness of food to be stored within the container or bag.

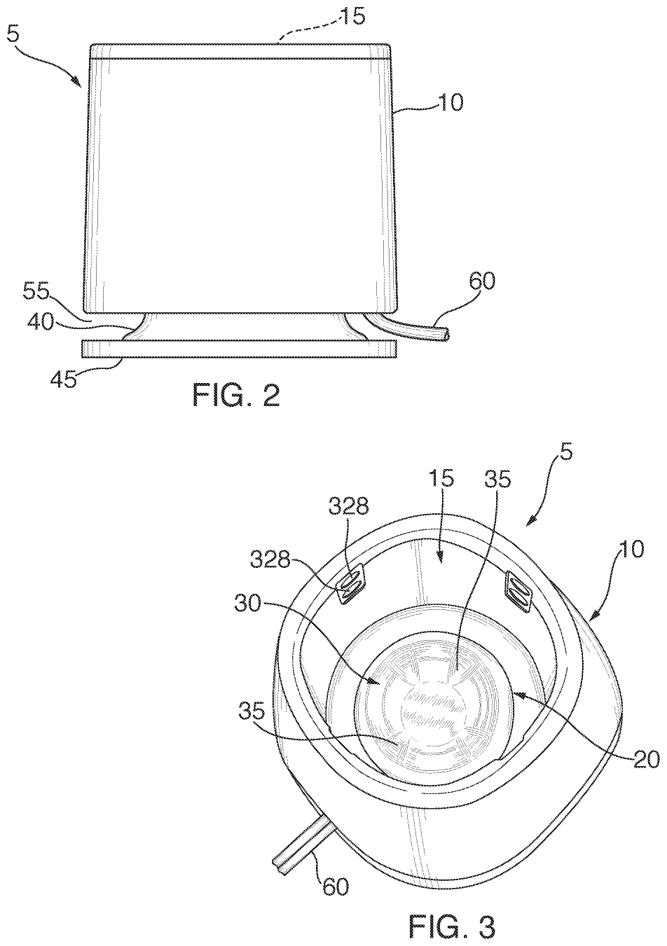

As shown in FIG. 2, the charging cradle 5 includes a charging section 10 formed as a body having a substantially square cross-section throughout its length. As illustrated, the substantially square-section has rounded corners. In other embodiments, the charging section 10 may have a circular, rectangular, or other cross-sectional shape across its length. The charging section 10 preferably includes a central cavity 15, as shown in FIG. 3, for receiving the sealer device 1. The central cavity 15 is therefore shaped and sized so the sealer device 1 can engage and mate with the charging section 10.

The central cavity 15 includes a cavity protrusion 20 that projects away from a base 25 of the central cavity 15. In the illustrated embodiment, the cavity protrusion 20 has a substantially circular cross-sectional shape across its longitudinal axis. A top surface 30 of the cavity protrusion 20 is preferably concave, with a downwardly extending depression. The top surface 30 preferably includes at least one cavity protrusion groove 35. The at least one cavity protrusion groove 35 may be located and positioned toward the edge or circumference of the cavity protrusion 20, and extends towards the center of the cavity protrusion 20. In the illustrated embodiment, the cavity protrusion 20 has four cavity protrusion grooves 35. The cavity protrusion 20 can include more or less cavity protrusion grooves 35 in alternative embodiments. Either alone or in combination, the concave shape of the top surface 30 and/or the at least one cavity protrusion grooves 35 preferably prevent the sealer device 1 from suctioning or sticking to the charging cradle 5 when engaged therewith.

Turing back to FIG. 2, the charger cradle 5 also includes a neck portion 40 that extends downwardly from the charging section 10 to a base portion 45. In other words, the neck portion 40 extends upwardly from the base portion 45 to connect the base portion 45 to the charging section 10. Either or both the neck portion 40 and the base portion 45 may be integrally formed with the charging section 10 or it may be selectively engageable therewith.

In the embodiment illustrated in FIG. 2, the base portion 45 is a substantially planar square member that rest on a surface, such as a counter top, table or other supporting surface. The base portion 45 may also include at least one base foot (not shown). The at least one base foot may be a protrusion that projects downwardly away from the base portion 45. In embodiments where the cradle 5 includes at least one base foot, the at least one base foot rests on a surface, such as a counter top, instead of the base portion 45. In one embodiment, the cradle 5 includes four circular base feet. In alternative embodiments, the number of base feet may differ, as can the shape and size of the base feet.

Like the base portion 45, the neck portion 40 also has a substantially square cross-section throughout its length. In other embodiments, the charging section 10, the base portion 45 and/or neck portion 40 may have a circular, rectangular or other cross-sectional shape across its length. The neck portion 40 is also preferably shaped so that it tapers as illustrated in FIG. 2 such that its diameter decreases in the direction from the base portion 45 to the cradle 5. Because the neck portion 40 tapers in this manner, a gap 55 may be provided surrounding the neck portion 40 and between the base portion 45 and the cradle 5.

A cord, such as cord member 60, may be used to supply power to the charging cradle 5 (and subsequently the sealer device 1) using known electronic methods. The cord member 60 may be wrapped around the neck portion 40 and stored within the gap 55. Thus, the cord member 60 may be shortened to a preferred length when the cradle 5 is resting on a supporting surface or completely shortened when a user wishes to store the cradle 5, for example, in a cabinet or drawer. Because the neck portion 40 is tapered, the cord member 60 preferably has a natural tendency to slide upwardly toward the charging section 10 when the cord member 60 is wrapped around the neck portion 40, within the gap 55, thereby forming a convenient and out of the way storage of the cord member 60 when the charging cradle 5 is not being used.

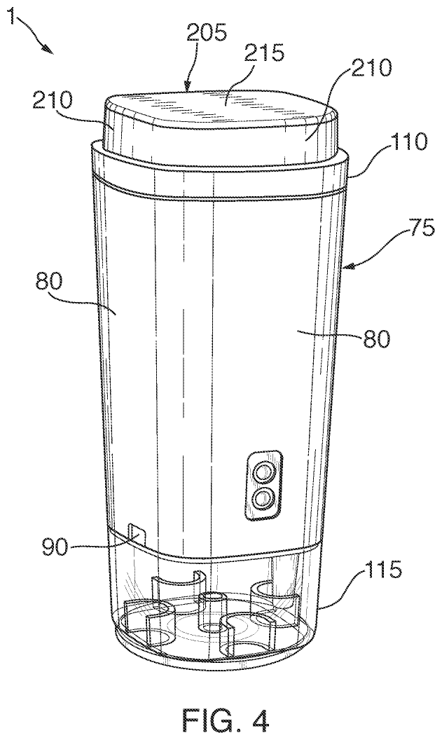

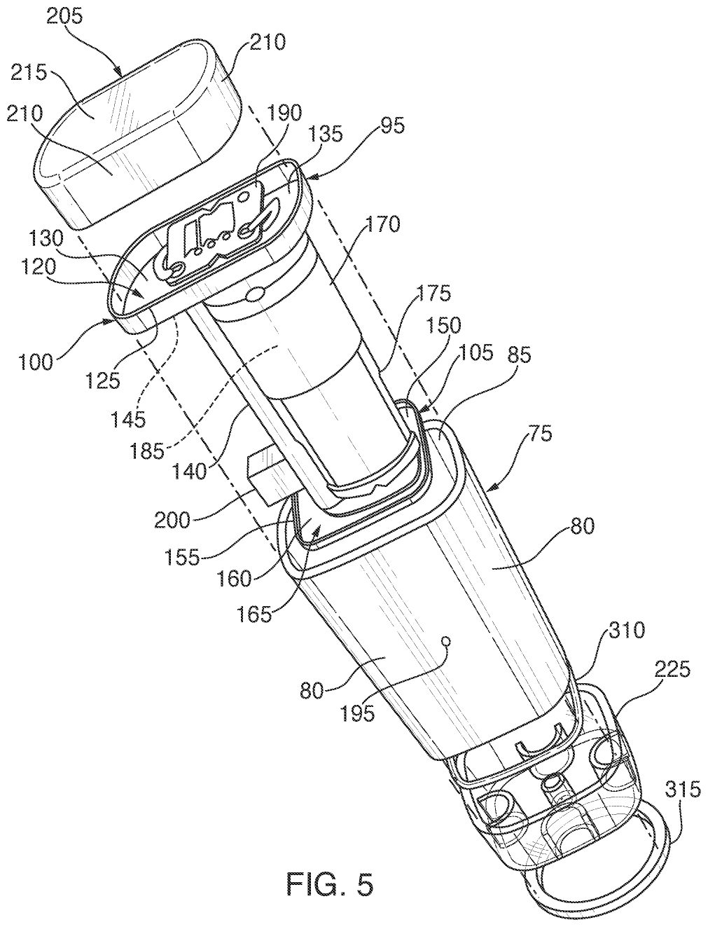

Turning to FIG. 4, the sealer device 1 has a first end 110 and a second end 115. The sealer device 1 is preferably provided with a body or housing 75 in which various components of the sealer device 1 may be contained and secured when the sealer device 1 is assembled. In the illustrated embodiment, the body 75 includes four sidewalls 80 to form a body cavity 85 (shown in FIG. 5). Thus, the body 75, like the cradle 5, preferably has a substantially square cross-section with rounded corners. Its cross-section, at its second end 115, preferably has a perimeter area just smaller than that of the central cavity 15 within the charging section 10. When the sealer device 1 is placed within the charging cradle 5, the body 75 and components contained therein may be snugly retained within the charging section 10. In the embodiment shown in FIG. 4, the body 75 tapers inwardly somewhat from the top (or first end) 110 to the bottom (or second end) 115, but in other embodiments, it may have a uniform cross-section across its length. Also, like the cradle 5, the body 75 may have a circular, rectangular, or other reasonably foreseeable cross-sectional shape along its length. The shape of body 75 should be compatible with the shape of the cradle 5 for obvious reasons.

The body 75 may also include an outlet port 90, which may be an aperture that extends through a sidewall 80 of the body. The outlet port 90 is located and positioned at the second end 115 of the body 75 and preferably helps prevent moisture from filling the body cavity 85, as will be explained hereinafter.

Various electronic and mechanical components used to operate the sealer device 1 may be contained within the body 75 when the sealer device 1 is assembled. As illustrated in FIG. 5, the body 75 includes a body casing 95 that may be used to contain the electric and mechanical components used to operate the sealer device 1. The body casing 95 may include a first receptacle 100 and a second receptacle 105 located and positioned the first end 110 (see FIG. 4) and the second end 115 (see FIG. 4) of the body casing 95, respectively. The first receptacle 100 preferably includes a first receptacle member 120, which is preferably a substantially planar rectangular member. The first receptacle 100 further includes a first rim 125 that surrounds the perimeter of the first receptacle member 120. The first rim 125 further projects away from the first upper face 130 to form a first receptacle cavity 135. The first receptacle 100 is therefore has a cup-like shape. The first receptacle 100 is preferably sized and shaped so that the body casing 95 may fit within the body cavity 85. Thus, the first receptacle 100 is preferably just smaller than the body cavity 85 at its first end 110 so that the first receptacle 100 preferably does not move within the body cavity 85.

The first receptacle 100 and the second receptacle 105 are spaced apart and connected by at least one post 140. The at least one post 140 is preferably a rectangular member that may be curved so that the components placed within the body casing 95 may be adjacent to and abut the post 140. The at least one post 140 preferably projects away from a first lower face 145 of the first receptacle 100, which is itself located opposite from the first upper face 130 of the first receptacle 100. The post 140 engages the second receptacle 105 at a second receptacle cavity 150. The first receptacle cavity 135 and the second receptacle cavity 150 preferably face the same direction.

Similarly to the first receptacle cavity 135, the second receptacle cavity 150 is formed through a second rim 155 that projects away from a second upper face 160 of a second receptacle member 165. The second receptacle 105 is also preferably a substantially planar rectangular member sized and shaped so that its perimeter is slightly smaller than the body cavity 85 at the second end 115. The second receptacle 105 may be the same shape as the first receptacle 100. When the body casing 95 is placed within the body cavity 85 of the body 75, the body casing 95 preferably does not shake or rattle within the body cavity 85.

In addition to the body casing 95, the body 75 preferably includes a pump member 170 and a motor 175 that may be secured and housed within the body casing 95 and further secured and housed within the body 75. The pump member 170 may be secured within the body casing 95 in a number of known or foreseeable ways. In the embodiment illustrated in FIG. 5, the pump member 170 is located and positioned at the first end 110 of the body casing 95, adjacent to and abutting the first receptacle 100. The pump member 170 is preferably a rotary diaphragm pump that allows for quiet operation when the sealer device 1 is activated in the manner described below. The rotary diaphragm pump, like those known and used in similar sealer devices, draws a vacuum from within the sealer device 1 by moving a flexible diaphragm which forces air in through an air inlet port (not shown) and then out by using control valves. Rotary diaphragm pumps, such as the rotary diaphragm pump member 170 shown in FIG. 5 may, in alternative embodiments, be replaced with other pump types known and understood in the art.

The pump member 170 is preferably driven by the motor 175. The motor 175 may be any of the types of motors known and understood in the art mechanically capable of operating the pump member 170. The motor 175 is illustrated as being located below the pump member 170 and is further located and positioned adjacent to the second receptacle 105. But in alternative embodiments, the pump member 170 and motor 175 may be alternatively oriented and arranged within the body casing 95 so long as they are in mechanical and electrical communication with one another.

The pump member 170 and the motor 175 are both preferably powered by a power source 185. While the power source 185 is shown as being positioned adjacent to the pump member 170 in the embodiment illustrated in FIG. 5, in alternative embodiments, it may be placed in a variety of locations within the body casing 95 so long as it is in electrical communication with the pump member 170 and the motor 175. In a preferred embodiment, the power source 185 is comprised of three ⅓ AA Ni-MH batteries. In alternative embodiments, the power source 185 may have a greater or less number of batteries. AA Ni-MH batteries are rechargeable and have sufficient power to drive the motor 175 and operate the pump member 170. In alternative embodiments, other rechargeable power sources may be used so long as they have sufficient power to operate the pump member 170 and motor 175.

A printed circuit board 190, or PCB, may also be arranged within the body casing 95.

More specifically, the PCB 190 may be located and positioned within the first receptacle cavity 135 of the body casing 95. The PCB 190 may include resistors, controllers, and other electronic and data components that may be required to operate and/or control the sealer device 1. The PCB 190 is also in electrical and mechanical communication with the electronic and mechanical components used to operate the sealer device 1.

At least one indicator 195, which may be embodied as an LED (light emitting diode) may also be located on a sidewall 80 of the body 75. The at least one indicator 195 may signal to a user when the sealer device 1 has been placed in the charging cradle 5 and the sealer device 1 is currently charging. The indicator 195 may further signal to a user that the sealer device 1 has low power or has been fully charged. A charge port 200, which is discussed in greater detail below, may also be located on the sidewall 80 of the body 75. Each of the indicator 195 and the charge port 200 should be in electronic communication with the PCB 190 as well as the power source 185. Thus, the power source 185 can provide power to the indicator 195 and the charge port 200, and the PCB 190 may read when the indicator 195 and the charge port 200 are being powered and/or when power should be provided to the indicator 195 and/or the charge port 200.

At the first end 110 of the sealer device 1, the sealer device 1 is preferably provided with an activation button 205. In the illustrated embodiment, the activation button 205 includes four sidewalls 210 that extend downwards from a top wall 215 forming a quadrilateral-like shape. The activation button 205 may have a substantially square cross-section. However, in alternative embodiments, the activation button 205 may have a circular, rectangular, or other reasonably foreseeable cross-sectional shape along its length, as long as it is compatible with the shape of body cavity 85, as will be explained hereinafter.

The perimeter of the activation button 205, formed from the sidewalls 210, is preferably slightly smaller than the body cavity 85 so that the activation button 205 may be slidingly engaged within the body 75 by a friction fit when the sealer device 1 is assembled. Thus, the sidewalls 80 of the body 75 are adjacent to and abut the sidewalls 210 of the activation button 205. A rim 220 of the activation button 205 is further adjacent to and abuts the first upper face 130 within the first receptacle cavity 135 of the body casing 95. In alternative embodiments where the cradle 5 and the body 75 take on alternative geometries, the activation button 205 may similarly take on those geometries so that it may fit within the body 75 as illustrated in FIGS. 1, 3 and 4. The activation button 205 preferably acts as an easily depressed mechanical spring switch to activate the motor 175 and the pump member 170 to draw a vacuum prior to sealing a bag or container as will be described below in greater detail.

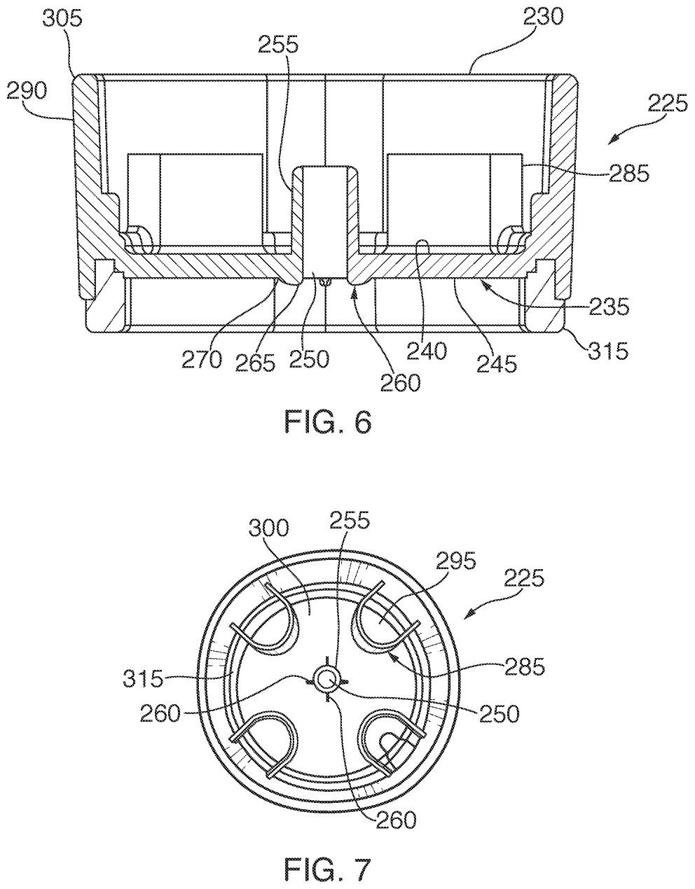

As shown in FIG. 5, but as can also be seen in FIGS. 6 and 7, at the second end 115 of the sealer device 1, a reservoir 225 is preferably provided. The reservoir 225 has an open top portion 230 and a mostly enclosed bottom portion 235, creating a cup-like structure. The bottom portion 235 of the reservoir 225 has opposing bottom faces: first bottom face 240 and second bottom face 245. The first bottom face 240 is located and positioned above the second bottom face 245, closer to the top portion 230. The second bottom face 245 is located and positioned opposite the first bottom face 240, at the second end 115 of the reservoir 225. The bottom portion 235 is only mostly enclosed because it includes an aperture 250 extending through its bottom portion 235. The aperture 250 is preferably located and positioned in the center of the bottom portion 235 of the reservoir 225. In alternative embodiments, the aperture 250 may be located and positioned in another area of the bottom portion 235. The reservoir 225 also has a reservoir sidewall 255 that extends away from the first bottom face 240 and circumscribes the aperture 250.

The reservoir 225 preferably further includes at least one reservoir rib 260. The reservoir rib 260 is preferably a triangular protrusion in a cross-sectional view taken across the length of the sealer device 1. The reservoir rib 260 projects away from the second bottom face 245, and is located and positioned adjacent to and may abut the aperture 250. Each reservoir rib 260 projects away from the second bottom face 245 at the aperture 250 at its first reservoir rib end 265, and then tapers towards the second bottom face 245 as the reservoir rib 260 extends away from the aperture 250. A second reservoir rib end 270 is preferably flush with the second bottom face 245. In the illustrated embodiment and as seen in FIG. 7, the reservoir 225 includes four reservoir ribs 260 spaced apart around the circumference of the aperture 250. In alternative embodiment, the reservoir 225 could have a greater or fewer number of reservoir ribs 260. The reservoir ribs 260 preferably help to ensure that the flexible material of a bag member 275 is not sucked into or pulled over the aperture 250, thereby blocking the aperture 250 due to the vacuuming process. The reservoir ribs 260 preferably prevent a portion of the bag member 275 from blocking the aperture 250 to allow the user to continue vacuuming without having to stop and readjust the bag member 275.

The reservoir 225 further includes at least one reservoir cup 285, as shown in FIG. 7. The at least one reservoir cup 285 is preferably a U-like shape structure that projects away from the first bottom face 240 of the bottom portion 235 of the reservoir 225. Each reservoir cup 285 preferably does not extend to the top portion 230 of the reservoir 225. The at least one reservoir cup 285 is preferably located and positioned so that the arms of the U-like shape are located adjacent to and abutting the perimeter or circumference 290 of the reservoir 225. Thus, each reservoir cup 285 sections off a portion of the reservoir 225, creating a reservoir cup section 295 within each reservoir cup 285. The rest of the reservoir 225 outside of the reservoir cups 285 is called inner reservoir section 300. As shown in the illustrated embodiment, the reservoir 225 may have four reservoir cups 285. However, in alternative embodiments, the number of reservoir cups 285 may differ, as can their shape.

The reservoir 225 may have a cross-section that is substantially square, but it may have an alternative cross-sectional shape when the cradle 5, charging section 10, base 10, body 75, and activation button 205 take on other shapes, as described above. The perimeter 290 of the reservoir 225, and particularly an upper perimeter at a rim portion 305 of the reservoir 225, is preferably just smaller than the area of the bottom portion of the body 75 so that when the reservoir 225 is inserted into the second end 115 of the body 75, it may be retained therein by a friction fit.

A sealing member 310 which is embodied as an O-ring in FIG. 5 may be positioned and located between the reservoir 225 and the second receptacle 105 when the reservoir 225 is engaged with the second receptacle 105. An airtight seal is preferably formed between the reservoir 225 and the second receptacle 105. Similarly, a seal member 315 may also be provided on the second end 115 of the reservoir 225, adjacent to and abutting the second bottom face 245. The seal member 315 may be permanently affixed to the reservoir 225. However, in alternative embodiments, the seal member 315 is releasably attachable to the reservoir 225. The seal member 315 is shaped and sized so that it circumscribes the cavity protrusion 20 and fits within the central cavity 15 when the sealer device 1 selectively engages with the charging station 5. When the sealer device 1 is operated, the seal member 315 may form an airtight seal with the vacuum port on a bag or container such that when a vacuum is drawn, air does not escape at a contact point between the seal member 315 and the bag or container.

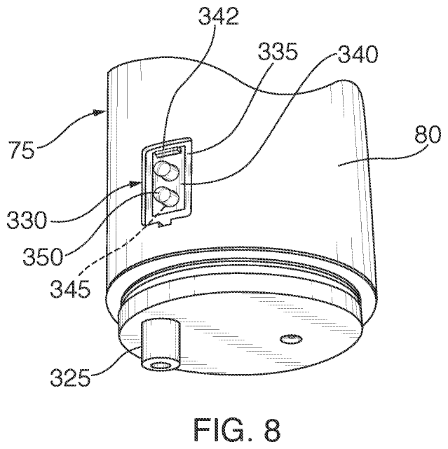

In FIG. 8, an accessory nozzle 325 is shown to extend downwardly from the body 75.

When the reservoir 225 is selectively engaged with the body 75, the accessory nozzle 325 may be located and positioned within one of the reservoir cup sections 295. The location of the accessory nozzle 325 preferably allows the size of the reservoir 225 to be decreased, while still maintaining reservoir 225 volume and also protects the accessory nozzle 325 from being damaged. In some embodiments, the accessory nozzle 325 may not be present.

In an alternative embodiment, the accessory nozzle 325 may be used in association with an accessory (such as a wine stopper, canister, jar, or other accessory) to vacuum air from within a vessel, like a wine bottle. In such an embodiment, when the accessory nozzle 325 is used to draw air from within such a vessel, the reservoir 225 is removed from the sealer device 1, and the accessory nozzle 325 is selectively engaged with the accessory. When the sealer device 1 is activated in the manner described above, air may be drawn from the vessel as air is drawn through the accessory nozzle 325. When the accessory nozzle 325 is included as a part of the sealer device 1, it is preferably molded into the bottom portion of the sealer device 1, but in some embodiments it may be selectively engageable with the device 1.

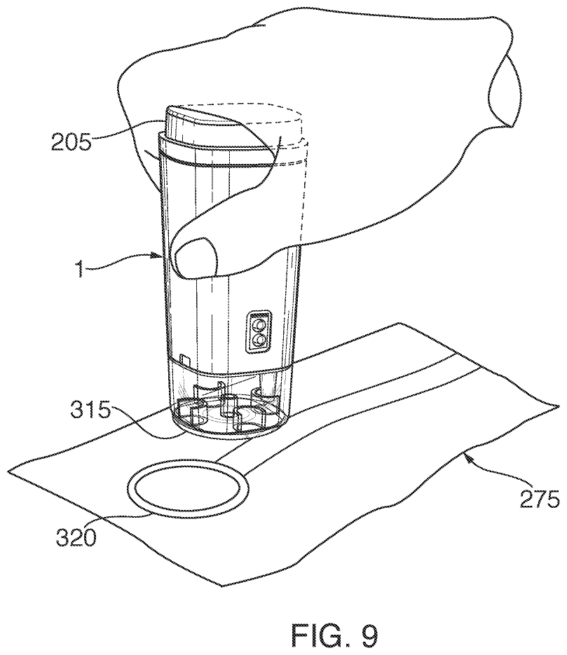

When the sealer device 1 is used, as illustrated in FIG. 9, a user may position the sealer device 1 so that the seal member 315 is positioned in substantial alignment with a port 320 of the bag member 275. In alternative embodiments, the seal member 315 may align with a port member (not shown) that is associated with a container such as plastic or glass storage containers that are known and understood in the art. When the user is ready to draw a vacuum from within the bag member 275, he or she may simply push downwardly on the sealer device 1 so that a seal is formed between the seal member 315 and the port 320. When a user pushes downwardly on the sealer device 1, the activation button 205 preferably has little resistance, but is similarly depressed. Engagement between the seal member 315 and the port 320, as well as the depression of the activation button 205, preferably occurs in one motion by the user. Because the activation button 205 is located at the top portion of the sealer device 1 and is easily depressed, it is easy for a user to activate the sealer device 1 at the same time he or she forms a seal with the bag member 275 or other container.

More particularly, when the activation button 205 is depressed, a mechanical spring located on an interior portion (not illustrated) of the activation button 205 completes an electronic circuit to initiate the vacuum process. Thus, the motor 175 may begin to operate the pump member 170 to generate a vacuum within the reservoir 225. That vacuum may then be passed through the aperture 250 in the second end 115 of the reservoir 225 and subsequently through the port 320 of the bag member 275 before ultimately drawing excess air from the bag member 275 (or in alternative embodiments, a container). In some embodiments, the pump member 170 may continue to operate as a vacuum until a user releases the activation button 205. In yet another embodiment, the pump member 170 may continue drawing a vacuum until the sealer device 1 senses that substantially all air has been drawn from the bag member 275 (or other container), and it automatically shuts off the motor 175 and thus the vacuum pump member 170.

As air is drawn from the bag member 275 into the device 1 through the reservoir 225, moisture accompany the air. Such moisture may be collected in the reservoir 225 to prevent the moisture from entering the body 75 where it could damage various electrical and mechanical components contained therein. More specifically, moisture is drawn up through the aperture 250 (shown in FIG. 7), over the reservoir sidewall 255 (shown in FIG. 6), and collected in the inner reservoir section 300. The reservoir sidewall 255 prevents the moisture from being released from the reservoir 225 through the aperture 250 when the vacuum is turned off. During operation, moisture continues to collect within the inner reservoir section 300, with the reservoir cups 285 preventing moisture from reaching the accessory nozzle 325, which is positioned within one of the reservoir cup sections 295. The volume of moisture within the inner reservoir section 300 may become great enough that the moisture spills over at least one reservoir cup 285 and starts to fill one or more reservoir cup sections 295. When the moisture starts to collect within the reservoir cup sections 295, the user can visibly see that the reservoir 225 has nearly reached full capacity, and the accessory nozzle 325 may soon start sucking up liquid. The reservoir 225 is preferably clear so that the user can see the moisture collecting within the reservoir 225. Once the reservoir cup sections 295 starts to fill, the user preferably ceases vacuuming to prevent the moisture from exiting the reservoir 225. Liquid that is sucked through the accessory nozzle 325 is preferably exhausted through the outlet port 90. Because of the outlet port 90 within the body 75, the moisture preferably does not accumulate within the body cavity 85 and reach the components within the body 75. The reservoir 225 is preferably easily selectively removable from the body 75 for easy cleaning.

In an alternative embodiment, the activation button 205 may be absent from the sealer device 1. In such an embodiment, the body 75 may extend upwards completely and have a closed top so as to completely encase the components contained therein, except at the bottom of the sealer device 1. Also, the reservoir 225 is adapted so that it is slidingly engaged with the bottom portion of the sealer device 1. The reservoir 225 may be positioned and located such that when a downward force is applied to the body 75, the body 75 movably slides towards the reservoir 225 and activates the vacuum pump member 170. Activation can be achieved in several different ways. The upper rim 80 of the reservoir 75 may act as a mechanical spring switch to close a circuit when the body 75 is moved downwardly onto a port associated with a bag or container thereby causing the motor 175 to begin driving the pump member 170 and drawing a vacuum in substantially the same manner as described above. Other electrical contacts can likewise be integrated into the bottom portion of the body 75 such that a downward force applied to the body 75 will engage the electrical contacts and activate the vacuum pump member 170. As such, when the user pushes down on the sealer device 1 to initiate the vacuum process, the downward movement of the body 75 onto the bag or container vacuum port will act as the activation switch. In this embodiment, like the one described above, it is easy for a user to activate the sealer device 1 at the same time he or she forms a seal with the bag member 275 or other container by simply pushing downwardly on the sealer device 1.

When the sealer device 1 is to be charged, it may be placed in the charging cradle 5. The power source 185 of the sealer device 1 may be recharged when the charge port 200 engages electrical contacts 328 (shown in FIG. 3) that are positioned and located on an interior of the charging cradle 5. More particularly, the charge port 200 of the sealer device 1 includes a socket cover 330 located and positioned on the sidewall 80 of the body 75. In the illustrated embodiment, the socket cover 330 may be only partially recessed into the sidewall 80. But in alternative embodiments, the socket cover 330 may project from the sidewall 80 or be recessed into the sidewall 80 of the body 75 so that the socket cover 330 is flush with the sidewall 80.

The socket cover 330 includes a first socket cover section 335 and a second socket cover section 340. The first socket cover section 335 is preferably a rectangular member. Similarly, the second socket cover section 340 is also a rectangular member that has a smaller area than the first socket cover section 335 and projects away from the first socket cover section 335. The second socket cover section 340 may include a limit rib 342 located and positioned at the first end 110 of the second socket cover section 340. The limit rib 342 is preferably a rectangular member that extends across the width of the first end 110 of the second socket cover section 340. The charge port 200 further includes at least one charging contact aperture 345. The at least one charging contact aperture 345 is an aperture that extends through both the first socket cover section 335 and the second socket cover section 340.

Therefore, each charging contact 350 extends through a charging contact aperture 345 of a socket cover 330 so that the charging contacts 350 may engage the electrical contacts 328 of the cradle 5. The interior of the cradle 5 preferably includes two circumferential electrical contacts or charger contact strips (not illustrated) that each are continuously formed to circumscribe the interior of the charging device 5. The electrical contacts 328 or charger contact strips on the interior of the cradle 5 preferably are at a height that allows the electrical contacts 328 to mate with and abut each of the contacts 350 when the sealer device 1 is placed in the cradle 5 thereby charging the sealer device 1. In an alternative embodiment, the strips may be a single strip, and the contacts 350 may be a single contact. However in any embodiment, no matter how the sealer device 1 is inserted into the charging cradle 5, the contacts 350 may abut some portion of the charger contact strip(s) that are found all the way around the interior of the charging cradle 5 to initiate the charging process using known electronic principles. Once the sealer device 1 has been placed into the cradle 5, the limit rib 342 preferably ensures that the sealer device 1 is not accidently dislodged by keeping the sealer device 1 centered and ensuring the contacts 350 do not lose contact with the charger contact strips.

In the illustrated embodiment, because the charging device 5 and the sealer device 1 have substantially square cross-sections, there are only four configurations by which the sealer device 1 may be placed in the charging cradle 5. However, in alternative embodiments, for example, where the sealer device 1 and the charging cradle 5 both have circular cross-sections, the sealer device 1 may be placed in a nearly limitless number of configurations within the cradle 5, and in any of those configurations, no matter how the user places the sealer device 1 within the charging cradle 5, the contacts 350 will abut the charger contact strip or strips in the interior of the charging cradle 5.

The preferred embodiments of the invention have been described above to explain the principles of the invention and its practical application to thereby enable others skilled in the art to utilize the invention in the best mode known to the inventors. However, as various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by the above-described exemplary embodiment, but should be defined only in accordance with the following claims appended hereto and their equivalents.

What is claimed is:

1. A handheld vacuum sealer device for generating a vacuum in a bag member or container, the sealer device comprising:
a body;
a motor secured and contained within the body;
a pump secured and contained within the body, the pump being driven by the motor when the sealing device is activated;
a power source secured and contained within the body in electrical communication with the motor for providing power thereto; and
an activation button that is releasably associated with the body such that when the body is pushed downwardly to form a seal between the sealer device and the bag member or container, the activation button is activated, and the motor drives the pump to generate a vacuum in the bag member or container;
wherein the sealer device further includes a reservoir that is selectively engageable with the body; and
wherein the reservoir includes an aperture extending through a bottom portion of the reservoir, the bottom portion of the reservoir have a first bottom face and a second bottom face, the reservoir further includes at least one reservoir rib located and positioned on the second bottom face adjacent to the aperture.

2. The sealer device of claim 1, wherein the reservoir includes at least one reservoir cup.

3. The sealer device of claim 2, wherein the sealer device further includes an accessory nozzle located and positioned within a reservoir cup.

4. A handheld vacuum sealer device for generating a vacuum in a bag member or container, the sealer device comprising:
a body;
a motor secured and contained within the body;
a pump secured and contained within the body, the pump being driven by the motor when the sealing device is activated;
a power source secured and contained within the body in electrical communication with the motor for providing power thereto; and
an activation button that is releasably associated with the body such that when the body is pushed downwardly to form a seal between the sealer device and the bag member or container, the activation button is activated, and the motor drives the pump to generate a vacuum in the bag member or container;
wherein the sealer device further includes a charge port; and
wherein the charge port includes a socket cover, the socket cover includes a limit rib to ensure that at least one charging contact does not lose contact with at least one charger contact strip.

5. A charging cradle for receiving and engaging a handheld vacuum sealer device having a charge port, the charging cradle comprising:
a cavity having a same cross-section shape as a cross-section shape of a body of the sealer device so that when the sealer device is placed in the charging cradle, the sealer device is snugly secured therein; and
at least one charging contact strip that circumscribes an interior of the cavity so that when the sealer device is placed in the charging cradle, the charge port of the sealer device abuts a portion of the at least one charging contact strip of the charging cradle regardless of the orientation of the sealer device; and
wherein the cavity includes a cavity protrusion, the cavity protrusion having a cavity protrusion top which is concave.

6. A charging cradle for receiving and engaging a handheld vacuum sealer device having a charge port, the charging cradle comprising:
a cavity having a same cross-section shape as a cross-section shape of a body of the sealer device so that when the sealer device is placed in the charging cradle, the sealer device is snugly secured therein; and
at least one charging contact strip that circumscribes an interior of the cavity so that when the sealer device is placed in the charging cradle, the charge port of the sealer device abuts a portion of the at least one charging contact strip of the charging cradle regardless of the orientation of the sealer device; and
wherein the cavity includes a cavity protrusion having a cavity protrusion top, the cavity protrusion top including at least one cavity protrusion groove.

7. A charging cradle for receiving and engaging a handheld vacuum sealer device having a charge port, the charging cradle comprising:
a cavity having a same cross-section shape as a cross-section shape of a body of the sealer device so that when the sealer device is placed in the charging cradle, the sealer device is snugly secured therein; and
at least one charging contact strip that circumscribes an interior of the cavity so that when the sealer device is placed in the charging cradle, the charge port of the sealer device abuts a portion of the at least one charging contact strip of the charging cradle regardless of the orientation of the sealer device; and
wherein the cavity includes a cavity protrusion, the cavity protrusion having a cavity protrusion top which is concave, the cavity protrusion further including at least one cavity protrusion groove.

8. A charging cradle for receiving and engaging a handheld vacuum sealer device having a charge port, the charging cradle comprising:
a cavity having a same cross-section shape as a cross-section shape of a body of the sealer device so that when the sealer device is placed in the charging cradle, the sealer device is snugly secured therein; and
at least one charging contact strip that circumscribes an interior of the cavity so that when the sealer device is placed in the charging cradle, the charge port of the sealer device abuts a portion of the at least one charging contact strip of the charging cradle regardless of the orientation of the sealer device; and
wherein the charging cradle includes a neck portion which extends downwardly to a base portion, the charging cradle further includes a gap where a cord member may be stored within the gap.

9. A vacuuming system for powering and generating a vacuum in a bag member or container, comprising:
a sealer device comprising:
a body;
a motor secured and contained within the body;
a pump secured and contained within the body, the pump being driven by the motor when the sealing device is activated;
a power source secured and contained within the body in electrical communication with the motor for providing power thereto; and
an activation button that is releasably associated with the body such that when the body is pushed downwardly to form a seal between the sealer device and the bag member or container, the activation button is activated, and the motor drives the pump to generate a vacuum in the bag member or container;
a charging cradle comprising:
a cavity having a same cross-section shape as a cross-section shape of a body of the sealer device so that when the sealer device is placed in the charging cradle, the sealer device is snugly secured therein; and
at least one charging contact strip that circumscribes an interior of the cavity so that when the sealer device is placed in the charging cradle, a charge port of the sealer device abuts a portion of the at least one charging contact strip of the charging cradle regardless of the orientation of the sealer device; and
wherein, the cavity of the charging cradle includes a cavity protrusion, the cavity protrusion having a cavity protrusion top which is concave, the cavity protrusion further including at least one cavity protrusion groove.

10. A vacuuming system for powering and generating a vacuum in a bag member or container, comprising:
a sealer device comprising:
a body;
a motor secured and contained within the body;
a pump secured and contained within the body, the pump being driven by the motor when the sealing device is activated;
a power source secured and contained within the body in electrical communication with the motor for providing power thereto; and
an activation button that is releasably associated with the body such that when the body is pushed downwardly to form a seal between the sealer device and the bag member or container, the activation button is activated, and the motor drives the pump to generate a vacuum in the bag member or container;
a charging cradle comprising:
a cavity having a same cross-section shape as a cross-section shape of a body of the sealer device so that when the sealer device is placed in the charging cradle, the sealer device is snugly secured therein; and
at least one charging contact strip that circumscribes an interior of the cavity so that when the sealer device is placed in the charging cradle, a charge port of the sealer device abuts a portion of the at least one charging contact strip of the charging cradle regardless of the orientation of the sealer device; and
wherein, the charge port of the sealer device includes a socket cover, the socket cover includes a limit rib to ensure that at least one charging contact does not lose contact with at least one charger contact strip of the charging cradle.

11. The vacuuming system of claim 10 wherein, the sealer device further includes a reservoir that is selectively engageable with the body, the reservoir includes at least one reservoir cup.

12. The vacuuming system of claim 11 wherein, an accessory nozzle is located and positioned within a reservoir cup.

13. The vacuuming system of claim 11 wherein, the reservoir includes an aperture extending through a bottom portion of the reservoir, the bottom portion of the reservoir have a first bottom face and a second bottom face, the reservoir further includes at least one reservoir rib located and positioned on the second bottom face adjacent to the aperture.
